(19) United States
(12) Patent Application Publication
(10) Pub. No.: US 2021/0283999 A1
(43) Pub. Date: Sep. 16, 2021

(54) LIFTGATE REINFORCEMENT ARRANGEMENTS

(71) Applicant: Magna Exteriors Inc., Concord (CA)

(72) Inventors: William J.J. Harney, Toronto (CA); Keijo J. Huotari, Fenton, MI (US); Mark P. Birka, Northville, MI (US); Heiner Salzmann, Metamora, MI (US); Gerard Oslzewski, Lambertville, MI (US); Steven Grgac, Mississauga (CA)

(73) Assignee: Magna Exteriors Inc., Concord (CA)

(21) Appl. No.: 16/334,632

(22) PCT Filed: Oct. 6, 2017
(86) PCT No.: PCT/IB2017/001366

§ 371 Date: Mar. 19, 2019

Related U.S. Application Data
(60) Provisional application No. 62/404,860, filed on Oct. 6, 2016.

(51) Int. Cl. B60J 5/10; B60J 5/04

(52) U.S. Cl. CPC B60J 5/107; B60J 5/045; B60J 5/0455; B60J 5/044; B60J 5/0441

(57) ABSTRACT

A liftgate structure having a composite inner panel with an outside surface having a lower perimeter surface area extending across the entire width of the composite liftgate structure. Connectable to the inner panel is a composite outer panel that has an inside surface with a lower perimeter surface area extending across substantially the entire width of the liftgate structure. Between the inner panel in the outer panel is a backing curtain. The backing curtain is connected to the outside surface of the inner panel such that the backing curtain is positioned between the outer panel on the inner panel and extends substantially across both the lower perimeter surface area of the inner panel and the lower perimeter surface area of the outer panel. The backing curtain prevents broken pieces of the outer panel for moving past the backing curtain in the event of an impact on the liftgate structure.

### CROSS-REFERENCE TO RELATED APPLICATIONS

This application claims the benefit of U.S. Provisional Application No. 62/404,860, filed Oct. 6, 2016. The disclosure of the above application is incorporated herein by reference.

### FIELD OF THE INVENTION

The present invention relates to liftgate systems for automobiles. More specifically, to a composite liftgate and method of manufacture.

### BACKGROUND OF THE INVENTION

One of the current trends in the automobile industry is to lower vehicle weight to help achieve better fuel economy, thus helping to meet fuel economy standards and to offset the higher fuel prices. Another trend is that there is a broader range of vehicle models, which in turn reduces the volume of vehicles produced on a per model basis. Liftgates are traditionally made from stamped steel panels that are heavy and have a high tooling cost and are susceptible to corrosion. Sheet Molding Compound (SMC) is an alternative to steel for the inner and outer panels of the liftgate. Using SMC has several manufacturing concerns related to the material and process. Steel and SMC liftgates have a mass penalty over thermoplastics. There are also styling restrictions with traditional sheet metal and SMC components.

In certain applications where liftgates are made from composite materials. Tethers made from steel are used to strengthen the liftgate. The use of steel tethers can be difficult to attach and increase the assembly complicity. It is therefore desirable to design liftgates that have tether systems that are easier to assemble, require less attachment points and still provide the desired level of strength to the liftgate.

In another aspect of the invention it is desirable to provide steel wire reinforcements between and connected with the inner and outer panels in order to further strengthen the liftgate. Traditionally steel wires or cables have been used to hold the liftgate together during a collision. However the traditional steel cables do not provide any type of strengthening features. It is therefore desirable to develop and provide new strengthening features either formed within the inner and outer panels are connected between the inner and outer panels that can be used to strengthen the overall liftgate structure as well as strengthen and support connection accessories such as light modules, door latches etc.

### SUMMARY OF THE INVENTION

A composite liftgate structure having a structural composite inner panel with an outside surface having a lower perimeter surface area extending across substantially the entire width of the composite liftgate structure. Connectable to the inner panel is a composite outer panel that has an inside surface with a lower perimeter surface area extending across substantially the entire width of the liftgate structure. Connected between the inner panel and the outer panel is a backing curtain. The backing curtain is connected to the outside surface of the inner panel such that the backing curtain is positioned between the outer panel on the inner panel and extends substantially across both the lower perimeter surface area of the inner panel and the lower perimeter surface area of the outer panel. The backing curtain prevents broken pieces of the outer panel for moving past the backing curtain in the event of an impact on the composite liftgate structure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective side view of a fabric backing curtain being incorporated on the composite liftgate structure according to a first embodiment of the present invention.

FIG. 2 is an exploded perspective side view of a mesh backing curtain being incorporated on the composite liftgate structure according to a second embodiment of the present invention.

FIG. 3 is an exploded perspective side view of a liftgate steel wire reinforcement arrangement on the composite liftgate structure according to a third embodiment of the invention.

FIG. 4 is an exploded perspective side view of a liftgate steel wire reinforcement arrangement incorporated on the composite liftgate structure according to a fourth embodiment of the invention.

FIG. 5 is an exploded perspective side view of a liftgate steel wire reinforcement arrangement on the composite liftgate structure according to a fifth embodiment of the invention.

FIG. 6 shows an enlarged sectional view of a portion of the composite liftgate structure with the joint surface between the inner and outer panel having two or more wires connected therebetween.

FIG. 7 is an enlarged view of a portion of FIG. 6.

FIG. 8 schematically depicts a method of creating a liftgate using adhesives according to one embodiment of the invention.

FIG. 9 schematically depicts a method of creating a liftgate using adhesives according to one embodiment of the invention.

FIG. 10 schematically depicts a method of creating a liftgate using adhesives according to another embodiment of the invention.

FIG. 11 schematically depicts a method of creating a liftgate using adhesives.

### DETAILED DESCRIPTION OF THE PREFERRED EMBODIMENTS

The following description of the preferred embodiment(s) is merely exemplary in nature and is in no way intended to limit the invention, its application, or uses.

The present invention seeks to address the above problems by providing presenting several different embodiments each having a unique solution to address the problems of preventing broken pieces of the liftgate from entering the vehicle compartment at the time of the collision and also providing structures that strengthen and support the components of the composite liftgate structure.

Referring now to the figures a composite liftgate structure 10, 100, 200, 300, 400 according to the various embodiments of the invention are now shown and described. All of the embodiments of the invention pertain to a composite liftgate structure having an inner panel 12 with an outside surface 14 having a lower perimeter surface area 16 extending across substantially the entire width of the composite liftgate structure 10, 100, 200, 300, 400. The inner panel 12 is generally formed of a structural composite material. The composite liftgate structure 10, 100, 200, 300, 400 also includes an outer panel 18 having an inside surface 20 with a lower perimeter surface area 22 extending across substantially the entire width of the composite liftgate structure 10, 100, 200, 300, 400. The outer panel 18 is also generally made of a composite material.

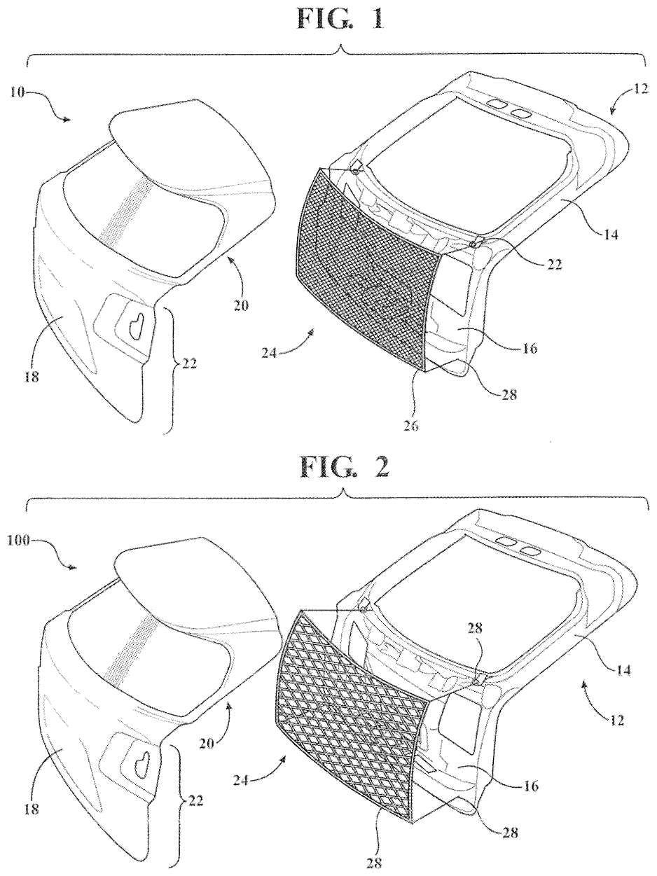

FIGS. 1 and 2 show embodiments of the composite liftgate structure having a backing curtain 24. The backing curtain 24 can take many forms. In the embodiment shown in FIG. 1 the backing curtain 24 is a fabric material 26 such as polypropylene, Kevlar, polyethylene fabric or ethyl vinyl acetate film. In another embodiment of the invention shown in FIG. 2 the backing curtain 24 is steel mesh or rubber mesh 28 having a lattice shape. In the embodiments shown in FIGS. 1 and 2 the backing curtain 24 connects to the inner panel 12 using different attachment structures 28, It is within the scope of this invention for the attachment structures to be one or more of the group consisting of loops, buttonholes and eyelets. Also it is within the scope of this invention for the backing curtain 24 to be a connected to other accessories connected to the inner panel 12. Such accessories include, but are not limited to a lock plate or lock mechanism, a damper or damper components such as a gas strut, wiper module, center high mounted stop lamp module, taillights or a rubber stop.

In another embodiment of the invention the backing curtain 24, when it is fabric or film can be connected to the inside surface 20 of the outer panel 18. Connection mechanisms can include adhesives, resistive implant welding, vibration welding, heat staking or overmolding, where the backing curtain is positioned between the outer panel on the inner panel and extends substantially across both the lower perimeter area of the inner panel and the lower perimeter surface area of the outer panel. In this embodiment of the invention the backing curtain prevents broken pieces of the outer panel from moving past the backing curtain in the event of an impact on the composite liftgate structure. If the outer panel breaks or is shattered into pieces the physical connection of the backing curtain with the inside surface of the outer panel will prevent the pieces from moving away from the rest of the outer panel.

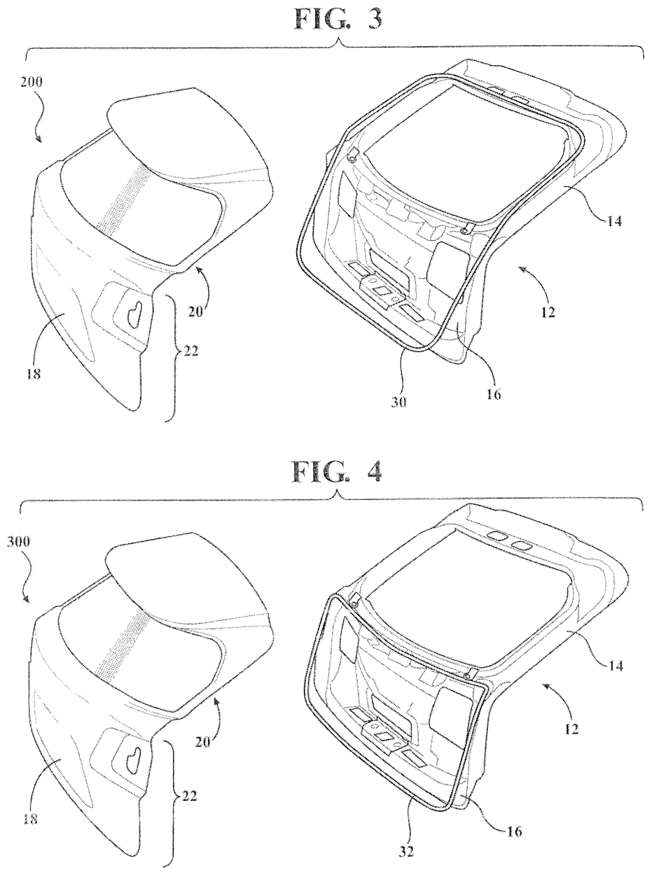

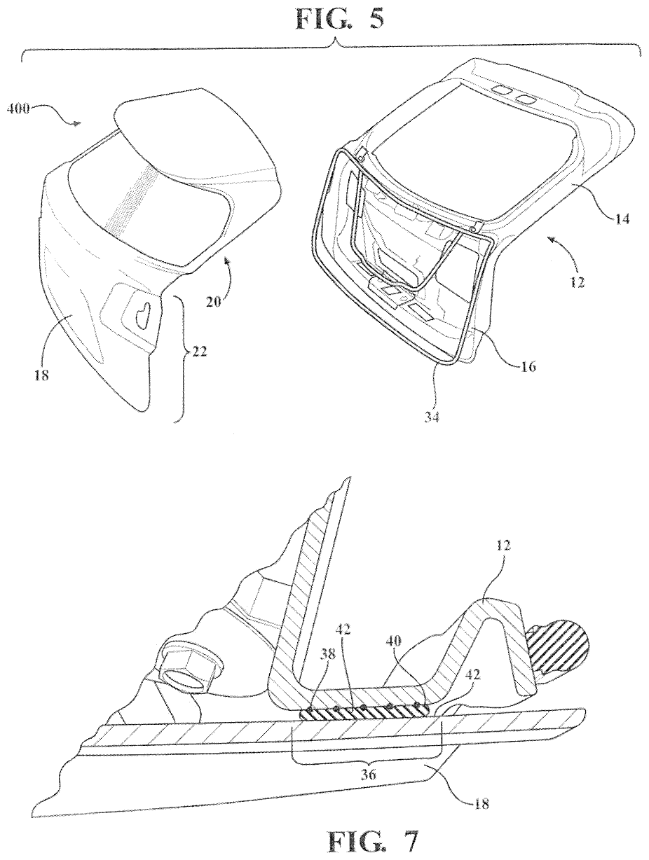

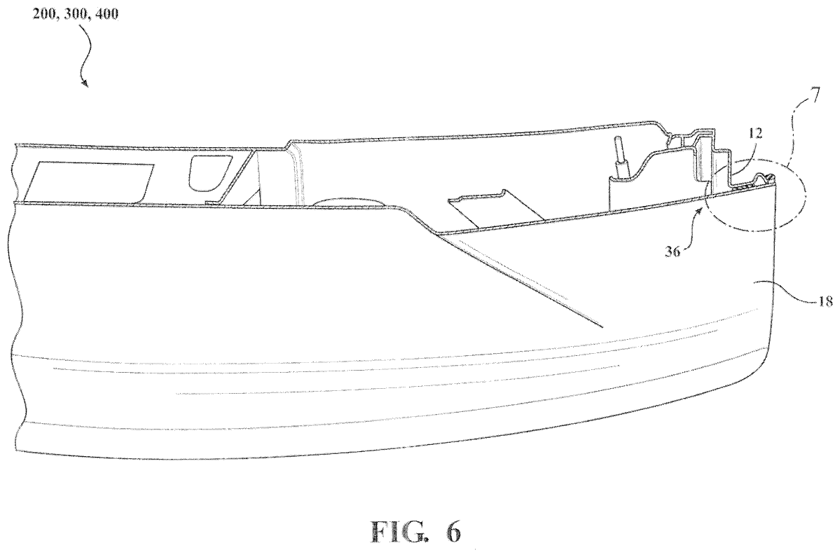

Referring now to FIG. 3 a steel wire reinforcement 30 is connected to the composite liftgate 200 in accordance with another embodiment of the present invention is shown. Another way of supporting or preventing the outer panel 18 from breaking or shattering into pieces and to also provide strength to the composite liftgate 200 is to provide the steel reinforcements 30 connected to strategic locations between the inner panel 12 on the outer panel 18. In the embodiment shown in FIG. 3 as well as the embodiments shown in FIGS. 4 and 5, there are composite liftgate structures 200, 300, 400 having an inner panel 12 and outer panel 18. The main difference is that in between the inner panel 12 and outer panel 18 there are two or more wires 32, 32, 34 overmolded to the inner panel 12 between the outer panel 18 and inner panel 18. As shown in FIGS. 6 and 7 there is an enlarged sectional view of a portion of the composite liftgate structure 200, 300, 400 with the joint surface between the inner and outer panel having two or more wires connected therebetween.

In the embodiment shown in FIG. 3 the steel wire reinforcements 30 are surrounding the full perimeter of the composite liftgate structure. In FIG. 4 the steel wire reinforcements 32 surround only the lower perimeter surface area of the inner and outer panel. In FIG. 5 the steel wire reinforcements 34 surround the lower perimeter in a gluing surface and bridge the D pillar section and connect the lower window area to the lock region of the inner panel.

Referring also to FIGS. 6 and 7 an alternate embodiment is shown where the two or more wires 32, 32, 34 are two or more reinforcement wires 38 within a joint surface 36 area formed by at least one surface 40 of the inner panel 12 and at least one surface 42 of the outer panel 18. As shown reinforcement wires 38 are connected to the inside surface 42 of the outer panel 18 using a using a connection layer 42, which is a layer of adhesives, molten resin from resistive implant welding, overmolding or some type of fastener. However it is possible to use vibration welding, heat staking, other suitable means.

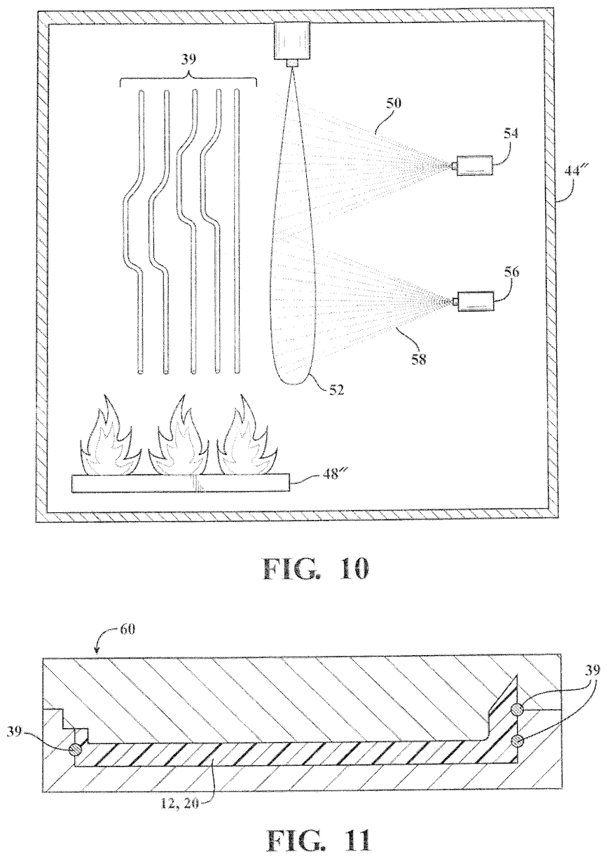

In order to better connect the two or more reinforcement wires 38 with the inner panel 12 and the outer panel 18, the two or more reinforcement wires 38 are pretreated prior to overmolding, which is best shown in FIGS. 8-11. The reinforcement wires 38 are preferably made of steel, but can also be made of aluminum, iron, metal alloys, polymer, polymer with fiber reinforcements or virtually any material having a suitable tensile strength. FIGS. 8-11 show a schematic of a method of creating an inner pane 12 or outer panel 20 of the composite liftgate structure 10, 100, 200, 300, 400 having overmolded reinforcement wires 39 using a couple of different processes for treating the reinforcement wires 39 to achieve better overmolding. The reinforcement wires 39 are arranged on the inner panel 12 and outer panel 20 in any type of pattern, including but not limited to those arrangements of the reinforcement wires 30, 32, 34, 38 shown in FIGS. 3-5. During a first step shown in FIG. 10 the metal reinforcement wires 39 are placed in an oven 44 having a heat source 48 and an adhesive coating 46 is applied to the reinforcement wires 38. The adhesive coating 46 can be applied using a spray, powder coating and then subsequently baking the rods, dipping or brushing the rods with the liquid adhesive or other suitable process for coating the rods with an adhesive. While the process is depicted as being done in an oven 44, it is within the scope of this invention for the adhesive coating 46 to be applied at ambient temperatures without any heating of the reinforcement wires 39 or adhesive.

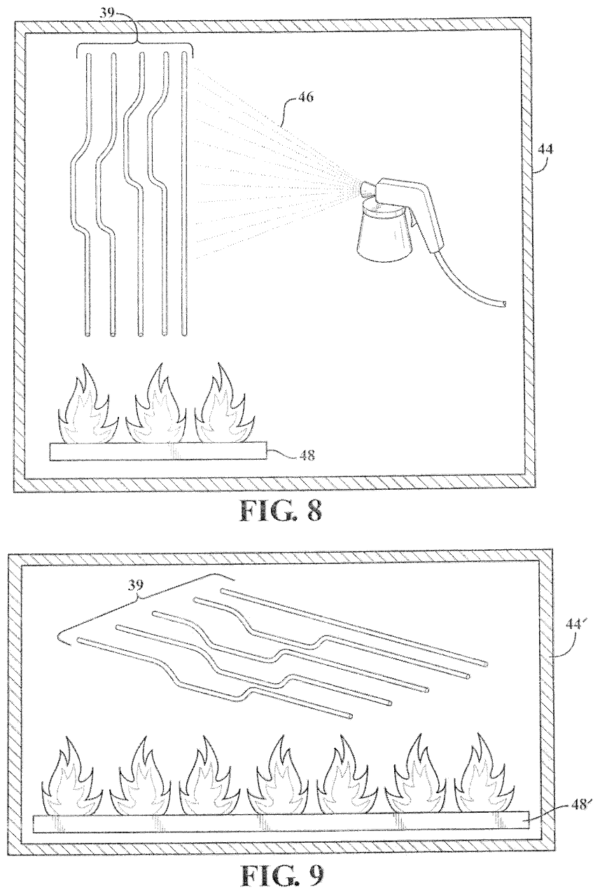

After the first step of coating the reinforcement wires 39, as depicted in FIG. 8, the reinforcement wires 39 with the coating are heated in an oven 44′ with a heat source 48′ as depicted in FIG. 9, which can be necessary for certain types of adhesives. However, as mentioned above the application of the adhesive can be done at ambient temperatures, and the step of heating the coated reinforcement rods 38 as shown in FIG. 9 is also not necessary for certain types of applications.

The type of adhesives contemplated being used in accordance with the present invention are generally nylon or polypropylene adhesives. However the specific adhesives can include other types of adhesives. In one aspect of the invention the adhesive used is THIXON™ 422, which is a one-component, solvent-based adhesive for bonding castable urethane to metal substrates, offering very good high temperature resistance. In another aspect of the invention the specific adhesive used is VESTAMELT® Hylink, which is a cross linkable adhesion promoter (e.g. a compound that makes the resin stick to the inner panel and to the individual reinforcement wires 38) for metal-plastic hybrid components with outstanding resistance to heat and mechanical stress. While THIXON™ 422 and VESTAMELT® Hylink are specifically mentioned it is within the scope of this invention for any suitable adhesive or adhesion promoter to be used provided whatever compound used makes the resin stick of the inner panel or outer panel of the composite liftgate structure 10, 100, 200, 300, 400 to the reinforcement wires 39.

In embodiments where the reinforcement wires 39 are coated in an oven or preheated before molding, as shown in FIGS. 8 and 9 it is within the scope of this invention for a suitable activation temperature to be greater than about 150° C., about 155° C., about 160° C., about 170° C., about 180° C. or any increments there between about 150° C. and about 180° C. The heating activation step two can occur at a later point in time, thus the coating of the reinforcement rod step can be accomplished at a different facility than where the activation step two occurs. However immediately after step two, when the reinforcement rod is heated to a suitable temperature as described above, the reinforcement rod is immediately placed into a mold cavity.

In embodiments where the coating step is carried out at ambient temperatures and no preheating of the rods is necessary or in embodiments shown in FIGS. 8 and 9, the adhesive used will cure with molten resin in a mold when the material in the mold reaches a suitable curing temperature. Suitable curing temperatures are generally greater than about 90° C., greater than between about 150° C. Depending on the particular adhesive used a curing temperature range between about 90° C. to about 150° C., between about 93° C. to about 104° C., a range between about 95° C. to about 145° C., a range between about 100° C. to about 140° C., a range between about 105° C. to about 135° C., a range between about 110° C. to about 130° C., a range between about 115° C. to about 125° C., a range between about 95° C. to about 120° C., a range between about 95° C. to about 115° C. a range between about 95° C. to about 110° C., a range between about 95° C. to about 105° C., a range between about 95° C. to about 100° C. or any sub-ranges there between is used.

Referring now to FIG. 10 a second embodiment of the invention is described. As shown in FIG. 10 reinforcement wires 39 are placed in an oven 44″ with a heat source 48″ and are coated in a single step using plasma spray technique where an adhesive 50 is applied by spraying the adhesive 50 through a plasma stream 52 located between sprayers 54, 56 and reinforcement wires 39. The plasma spray technique coats the reinforcement wires 39 with a charged adhesive or adhesion promoter. During a first step the first plasma spray is sprayed onto the reinforcement wires 39 to clean the reinforcement wires 39. Then at a second step a saline stream 58 of plasma from sprayer 56 having a cross-linking adhesive is sprayed onto the reinforcement wires 39. This first step is carried out in an oven where the reinforcement wires 39 and plasma sprays are applied in environment that is between about 160° C. to about 180° C. or any temperature there between. However, depending on the type of adhesives it is possible that both of the above steps occur at ambient temperatures, with the adhesives having the same curing temperature ranges as described above with respect to FIGS. 8 and 9.

Referring to FIG. 11 after the second plasma stream is applied to the reinforcement wires 39, the reinforcement wires 39 are placed into a forming cavity 58, which part of a forming machine 60. The machine 60 can be any type of machine used suitable for overmolding the reinforcement wires 39 with the inner panel 12, and can include a sheet mold compound forming machine, injection molding machine, resistive implant welding machine, thermoforming machine. The machine 60 applies resin, heat and pressure necessary to form the inner panel 12 or outer panel 20 of the composite liftgate structure 10, 100, 200, 300, 400. FIG. 11 shows a side cross-sectional view of a closed mold with the mold cavity 58. The reinforcement wires 39 are shown overmolded within the resin.

While an oven 44, 44′, 44″ is described above, the oven can take many forms such as an infrared oven or heating element, resistive implant welding unit, laser or any other suitable means of inducing heat to the reinforcement element. The oven can also be just a fan that blows ambient air onto the coated reinforcement wires 39 to promote drying of the adhesive.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A composite liftgate structure, comprising:
a structural composite inner panel with an outside surface with a lower perimeter surface area extending across substantially the entire width of the composite liftgate structure;
a composite outer panel having an inside surface with lower perimeter surface area extending across substantially the entire width of the composite liftgate structure;
a backing curtain connected to the outside surface of the inner panel such that the backing curtain is positioned between the outer panel and the inner panel and extends substantially across both the lower perimeter surface area of the inner panel and the lower perimeter surface area of the outer panel, wherein the backing curtain prevents broken pieces of the outer panel from moving past the backing curtain in the event of an impact on the composite liftgate structure.

2. The composite liftgate structure of claim 1, wherein the backing curtain is fabric such as polypropylene.

3. The composite liftgate structure of claim 2 wherein the backing curtain has warp tensile strength of one selected from the group consisting of greater than about 77 lb/in, greater than about 95 lb/in, greater than about 242 lb/in, greater than about 258 lb/in, greater than about 275 lb/in, greater than about 280 lb/in, greater than about 295 lb/in, greater than about 312 lb/in, greater than about 363 lb/in, greater than about 396 lb/in, and greater than about 429 lb/in.

4. The composite liftgate structure of claim 1 wherein the inner panel further comprises one of loops, buttonholes and eyelets for connecting the backing curtain to the inner panel.

5. The composite liftgate structure of claim 1 wherein the backing curtain is connected to other accessories connected to the inner panel including one of the group consisting of a lock, a damper, a wiper module or a rubber stop.

6. The composite liftgate structure of claim 1 wherein the backing curtain is steel mesh or rubber mesh.

7. The composite liftgate structure of claim 5 wherein the inner panel further comprises one of loops, buttonholes and eyelets for connecting the steel mesh or rubber mesh to the inner panel.

8. The composite liftgate structure of claim 5 wherein the steel mesh or rubber mesh is connected to other accessories connected to the inner panel including one of the group consisting of a lock, a damper, a wiper module or a rubber stop.

9. A composite liftgate structure, comprising:
a structural composite inner panel with an outside surface with a lower perimeter surface area extending across substantially the entire width of the composite liftgate structure:
a composite outer panel having an inside surface with lower perimeter surface area extending across substantially the entire width of the composite liftgate structure;
a backing curtain connected to the inside surface of the outer panel using adhesives, resistive implant welding, vibration welding, heat staking or overmolding, wherein the backing curtain is positioned between the outer panel and the inner panel and extends substantially across both the lower perimeter surface area of the inner panel and the lower perimeter surface area of the outer panel, wherein the backing curtain prevents broken pieces of the outer panel from moving past the backing curtain in the event of an impact on the composite liftgate structure.

10. The composite liftgate structure of claim 8 wherein the backing curtain is polyethylene fabric of ethyl vinyl acetate film.

11. A composite liftgate structure, comprising:
a structural composite inner panel with an outside surface with a lower perimeter surface area extending across substantially the entire width of the composite liftgate structure;
a composite outer panel having an inside surface with lower perimeter surface area extending across substantially the entire width of the composite liftgate structure;
two or more wires overmolded to the inner panel between the outer panel and the inner panel.

12. The composite liftgate of claim 10 further comprising:
at least one joint surface formed by at least one surface of the inner panel and at least one surface of the outer panel nesting together, wherein the at least one joint surface aligns and provides one point of connection between the outer panel and the inner panel; and
wherein the two or more wires are placed within the at least one joint surface and are fixed within the at least one joint surface.

13. The composite liftgate of claim 11 wherein the two or more wires are metal and the inner panel is formed from urethane polymer.

14. The composite liftgate of claim 13 further comprising a one component solvent based nylon or polypropylene adhesive coating on the two or more wires.

15. The composite liftgate system of claim 11 wherein the two or more wires are coated with a cross-linkable adhesion promoter.
